(19) United States
(12) Patent Application Publication
(10) Pub. No.: US 2013/0236736 A1
(43) Pub. Date: Sep. 12, 2013

(54) ELECTROPLATING JIG FOR PROCESSING ELECTROPLATING AT CERTAIN LOCATION, ELECTROPLATING METHOD INCORPORATING WITH THE SAME, AND ELECTRO PRODUCT FREE OF PLATING PROOF LAYER PRODUCED THEREBY

(71) Applicants: Tzuh-Suan WANG, Hsinchu (TW); Ming-Chi Chiu, Hsinchu (TW); Yu-te Su, Hsinchu (TW); Ming-Chang Ku, Hsinchu (TW)

(72) Inventors: Tzuh-Suan WANG, Hsinchu (TW); Ming-Chi Chiu, Hsinchu (TW); Yu-te Su, Hsinchu (TW); Ming-Chang Ku, Hsinchu (TW)

(73) Assignee: Winstron NeWeb Corporation

(21) Appl. No.: 13/604,251

(22) Filed: Sep. 5, 2012

(30) Foreign Application Priority Data
Mar. 9, 2012 (TW) 101108105

(51) Int. Cl. C25D 17/06; B32B 3/30; C25D 5/02

(52) U.S. Cl. 428/601; 204/297.01; 205/118

(57) ABSTRACT

An electroplating jig for processing electroplating at a certain location, an electroplating method incorporating with the electroplating jig, and an electro product free of a plating proof layer produced by the electroplating method are provided. The electroplating jig includes a base and a flexible electric conductive pad. An accommodation slot and an opening are respectively installed on two opposite surfaces of the base in which an electro can be disposed in the accommodation slot and the accommodation slot is larger than the opening and communicated with the opening, the opening exposes a first metal pattern of the electro therefrom. The flexible electric conductive pad is blanketed on a second metal pattern formed on another surface of the electro to electrically connect the first metal pattern and the second metal pattern.

### RELATED APPLICATIONS

This application claims priority to Taiwanese Application Serial Number 101108105, filed Mar. 9, 2012, which is herein incorporated by reference.

### BACKGROUND

1. Technical Field

The present invention relates to an electroplating jig, and more particularly to an electroplating jig for processing electroplating at a specific location.

2. Description of Related Art

With the rapid development of information technology, a portable electronic device, e.g. a mobile phone, personal digital assistant (PDA) and a notebook computer, is more and more common in our daily life. It also obtains more and more attention whether the portable electronic device has a housing with a good looking and quality.

Normally, the housing of the mentioned portable electronic device is disposed with an electric conductive layer for the electrical connection between circuits in the electronic device and the electric conductive layer. To obtain a better electric conductive performance for the electric conductive layer, a metal layer having better electric conductivity is often additionally electroplated on the top of the electric conductive layer. However, a plane-electroplating equipment can only be used to selectively electroplate the electric conductive layer with a flat surface, but not to the one with nonplanar contour having a three-dimensional surface.

Consequently, there is still a need to improve the inconvenience and disadvantages such as the aforementioned electroplating method in the art, so as to effectively eliminate the inconvenience and disadvantages.

### SUMMARY

The present invention provides an electroplating jig for processing electroplating at a certain location, an electroplating method incorporating with the electroplating jig, and an electro product free of a plating proof layer thereon produced by the electroplating method, which solves the inconvenience and disadvantage in the art, thereby lowering the manufacturing and labor cost. Further, even for a certain location locally defined on an electro, the electroplating target of the electro can still be processed with electroplating, thereby providing simplified production steps. Moreover, according to embodiments of the present invention, only the electroplating target of an electro is exposed, and other locations not being defined as the electroplating targets are shielded, so as to prevent electroplating solution from polluting the other locations which are not electroplating targets defined on the electro.

In one embodiment, the electroplating jig of the present invention is adopted into an electroplating process together with an electro in which two opposite surfaces of the electro respectively have a first metal pattern and a second metal pattern which are electrically connected. The electroplating jig includes a base and a flexible electric conductive pad. The base includes a first surface and a second surface opposite to the first surface. The first surface is provided with an accommodation slot concavely formed thereon, and the accommodation slot is configured to receive the electro therein. The second surface is arranged oppositely to the first surface, and is provided with an opening formed thereon. The opening is smaller than the accommodation slot, and is in communication with the accommodation slot. The opening is configured to expose the first metal pattern of the electro from the opening. The flexible electric conductive pad is removeably covered on the accommodation slot, mated with a contour of the electro to cover on both of the electro and the second metal pattern so as to electrically connect the first metal pattern and the second metal pattern.

In another embodiment, an electroplating method is provided, and the electroplating method comprises an electro in the foregoing electroplating jig is placed in which the soft electric conductive pad is electrically connected to a cathode electrode of a power source; and an electroplating solution is sprayed on the first metal pattern in the opening of the electroplating jig for conducting the electroplating process to the first metal pattern in which the electroplating solution is electrically connected to a positive electrode of the power source.

Yet another embodiment may provide an electro product free of a plating proof layer, which is produced by the forgoing electroplating method. The electro product comprises a carrier, a first metal pattern, a first metal electroplating layer, a second metal pattern, a second metal electroplating layer, a first metal conductive portion, a third metal pattern, a third metal electroplating layer and a metal secondary electroplating layer. The carrier is provided with a first surface, a second surface and a penetrated hole. The first surface is opposite to the second surface, and the penetrated hole is communicated with the first surface and the second surface. The first metal pattern is formed on the first surface. The first metal electroplating layer is formed on the first metal pattern, and electrically connected to the first metal pattern. The second metal pattern is formed on the second surface. The second metal electroplating layer is formed on the second metal pattern, and electrically connected to the second metal pattern. The first metal conductive portion is disposed in the penetrated hole, electrically connected to the first metal pattern and the second metal pattern. The third metal pattern is formed on the first surface. The third metal electroplating layer is formed on the third metal pattern, and electrically connected to the third metal pattern, and the third metal electroplating layer is exposed to the atmosphere. The metal secondary electroplating layer is formed on the first metal electroplating layer, and electrically connected to the first metal electroplating layer.

As disclosed above, with the electroplating jig, the electroplating method and the electro product free of the plating proof layer are provided by the present invention, even when the electroplating target of the electro is three-dimensional, the electroplating jig can still be used to achieve the objective of electroplating at certain location, so as to lower the manufacturing cost. In addition, with the electroplating jig incorporating with the electroplating method of the electroplating job provided by the present invention, only the electroplating target of the electro is exposed, and other locations not being defined as the electroplating targets are shield, so as to prevent the electroplating solution from polluting the other locations which are not electroplating targets defined on the electro.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view illustrating an electroplating jig and an electro according to one embodiment of the present invention;

FIG. 2 is a schematic view illustrating the assembly of the electroplating jig and the electro shown in FIG. 1;

FIG. 3 is a schematic partial view illustrating the assembly of the electroplating jig and another electro according to an embodiment of the present invention;

FIG. 4 is a top view of the electroplating jig according to another embodiment of the present invention;

FIG. 5 is a flowchart illustrating an electroplating method provided by an embodiment of the present invention;

FIG. 6 is a schematic view illustrating the operation of the STEP (204) according to the electroplating method provided by an embodiment of the present invention;

FIG. 7A is a schematic view illustrating an alternative of the electro product according to an embodiment of the present invention;

FIG. 7B is a schematic view illustrating another alternative of the electro product according to an embodiment of the present invention;

FIG. 7C is a schematic view illustrating one another alternative of the electro product according to an embodiment of the present invention; and

FIG. 7D is a schematic view illustrating still one another alternative of the electro product according to an embodiment of the present invention.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

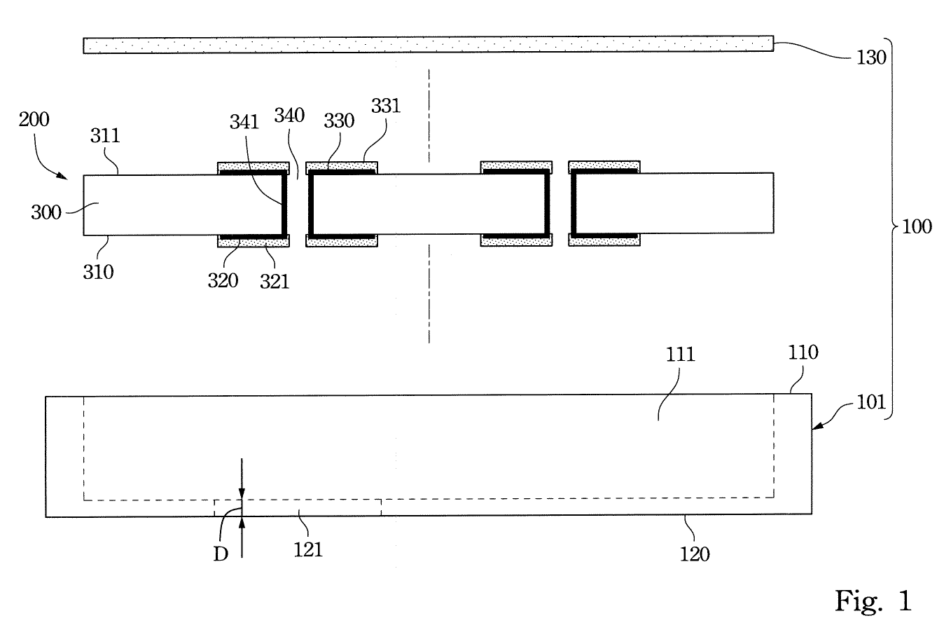

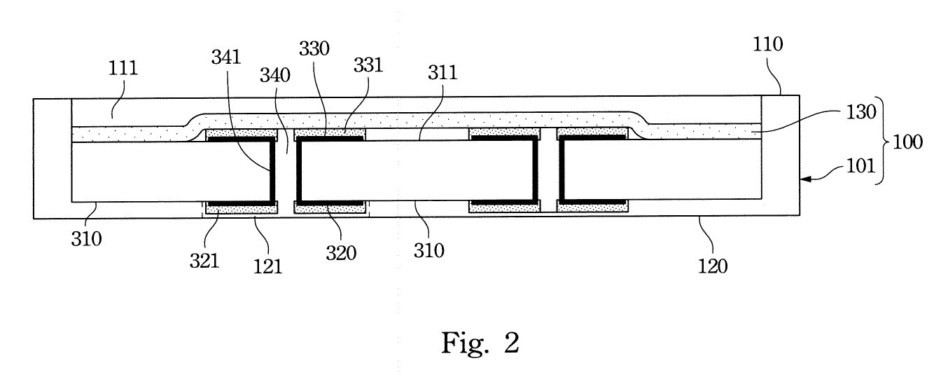

Reference will now be made to FIG. 1 and FIG. 2 in which FIG. 1 is an exploded view illustrating an electroplating jig 100 and an electro 200 according to one embodiment of the present invention, and FIG. 2 is a schematic view illustrating the assembly of the electroplating jig 100 and the electro 200 shown in FIG. 1.

According to one embodiment of the present invention, the electroplating jig 100 of the present invention, which is applicable to be adopted to an electroplating process together with an electro 200, in which one or more electroplating targets defined on the electro 200 are exposed, and other locations of the electro 200, which are not defined as the electroplating targets, are shielded.

Referring to FIG. 1, the electro 200 includes a carrier 300, a first surface 310 and a second surface 311 oppositely defined on the carrier 300 are respectively formed with a first metal pattern 320 and a second metal pattern 330 which are electrically connected.

The electroplating jig 100 at least includes a base 101 and a soft (or flexible) electric conductive pad 130. The base 101 is formed in a plate-like shape, and includes a first surface 110 and a second surface 120 opposite to the first surface 110. The first surface 110 is concavely formed with an accommodation slot 111 in which the electro 200 is received in the accommodation slot 111, the dimension of the accommodation slot 111 can be substantially mated with the dimension of the electro 200, such that the electro 200 can be fixed and mounted in the accommodation slot 111. The second surface 120 is formed with at least an opening 121, and the area of the opening 121 formed on the second surface 120 is smaller than the area of the accommodation slot 111 formed on the first surface 110. The opening 121 is in communication with the accommodation slot 111. When the electro 200 is received in the accommodation slot 111, an electroplating target of the electro 200, e.g. the first metal pattern 320, is exposed from the opening 121. It is noted that the arranged location and the quantity of the opening 121 are corresponding to the arranged location and the quantity of the electroplating target of the electro 200.

For example, the base 101 can be formed in a soft state and provided with properties such as electric insulation, acid and alkaline proof and wearing resistance, e.g. insulation materials such as silicone, plastic or rubber; However, the scope of the present invention is not limited to the mentioned insulation materials.

In addition, after the electro 200 is received in the accommodation slot 111, the communication between the accommodation slot 111 and the opening 121 is blocked by the electro 200, so as to prevent an electroplating solution 500 from penetrating into the accommodation slot 111 from the opening 121, so the objective of electroplating at certain position can be successfully carried out.

The soft electric conductive pad 130 can be moved to cover on the accommodation slot 111 of the first surface 110 of the base 101, or removed from the base 101. After the soft electric conductive pad 130 is covered on the accommodation slot 111, the soft electric conductive pad 130 can cover on both of the electro 200 and the second metal pattern 330, so as to enable the second metal pattern 330 to be electrically connected to the first metal pattern 320. For example, the soft electric conductive pad 130 can be an electric conductive rubber, an electric conductive fabric or an electric conducive tape; however, the scope of the present invention is not limited to the mentioned electric conductive components.

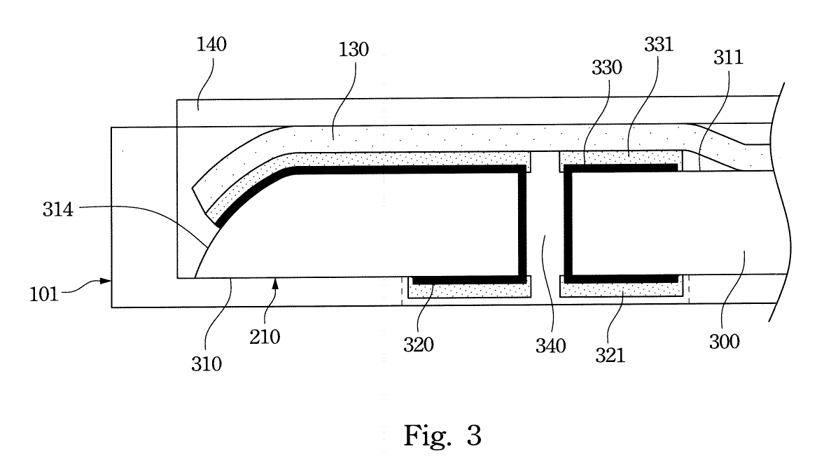

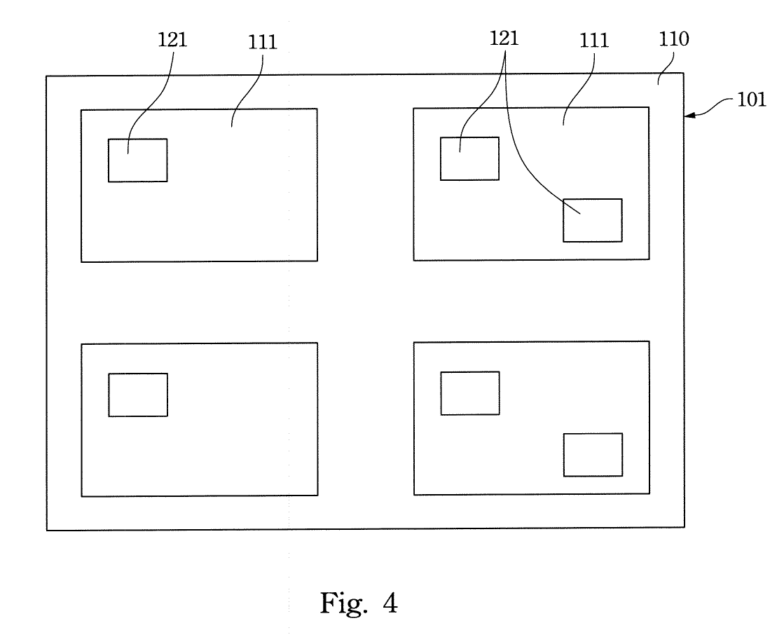

FIG. 3 is a schematic partial view illustrating the assembly of the electroplating jig 100 and another electro 210 according to the present invention. Since the soft electric conductive pad 130 is with flexibility, thus, when the second surface 311 of the electro 210 is formed as a non-planar surface, e.g. an arc-shaped surface 314, and the second metal pattern 330 is formed on the arc-shaped surface 314, the soft electric conductive pad 130 can incorporate with the contour of the electro 200 for fully covering or blanketing on the second surface 311 of the electro 200, so as to completely contact with the second metal pattern 330 of the second surface 311 of the electro 200.

According to an alternative of this embodiment, the electroplating jig 100 can further includes an outer cover 140 (as shown in FIG. 3). The outer cover 140 is formed in a plate shape with a rigid state, and has a considerable weight, thus, the outer cover is able to press the soft electric conductive pad 130 on the electro 200, such that the soft electric conductive pad 130 can be more adjacent to the surface of the electro 200.

A such, regardless the electroplating target of the electro 200 being in a three dimensional or planar shape, because the opening 121 of the second surface 120 of the base 101 has a certain depth D (as shown in FIG. 1), and the certain depth D is deep enough, so the electroplating target, e.g. the first metal pattern 320, of the electro 200 exposed from the opening 121 can still be accommodated inside the opening 121. For example, the electroplating target, e.g. the first metal pattern 320, of the electro 200 is in a three dimensional shape, the first metal pattern 320 extends into the opening 121 from the accommodation slot 111 but still can be accommodated inside the opening 121.

It is noted that the first surface 110 of the electroplating jig 100 can be concavely formed with a plurality of accommodation slots 111, and the quantity of the opening 121 of the second surface 120 of each accommodation slot 111 can be plural, so an operator can adjust with respect to the actual needs of required location and quantity of the electroplating target.

The timing in which the electro 200 and the electroplating jig 100 being mated for operation is not limited to how many times the electroplating has been processed; as such, the first metal pattern 320 and the second metal pattern 300 are not limited to whether being electroplated with a metal electroplating layer.

Because the electroplating jig 100 can be utilized to partially electroplate the electro 200 at certain location, the scope of the present invention is not limited to whether the location where the first surface 310 of the electro 200 not corresponding to the opening 121 can be provided with other metal patterns; in other words, the first surface 310 of the electro 200 can be only provided with the mentioned first metal pattern 320, and also can be provided plural metal patterns which are not the electroplating targets.

Moreover, for the electro 200 which has already been processed with a primary electroplating, the electroplating jig 100 still can be selectively used for the selective secondary electroplating, i.e. when the first metal pattern 320 and the second metal pattern 330 of the electro 200 has been respectively coated by a metal electroplating layer, the electroplating target, e.g. the first metal pattern 320, can still be processed with a secondary electroplating.

As such, the following will illustrate the electroplating method processed through the electro 200 incorporating with the electroplating jig 100 and the electro 200 produced by the electroplating method.

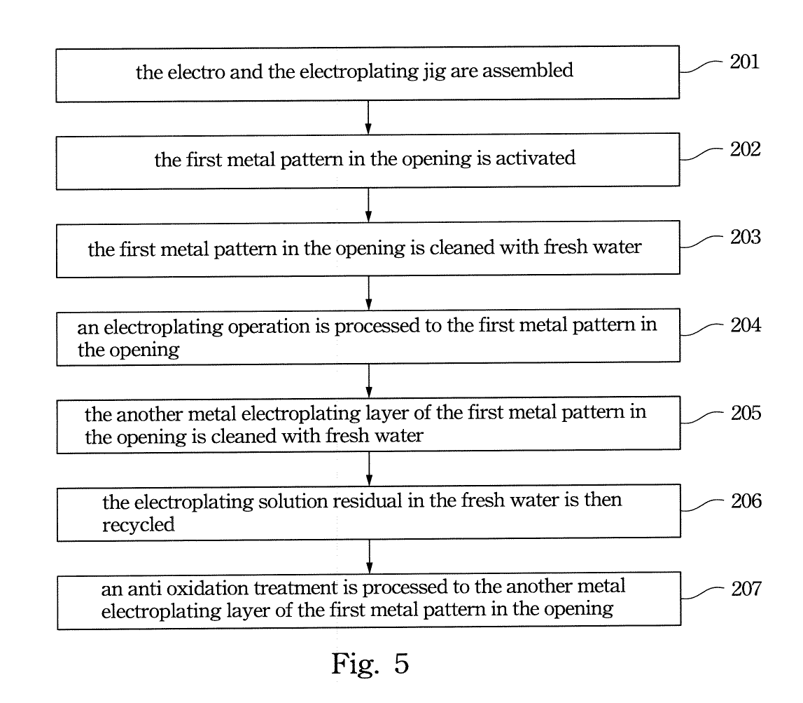

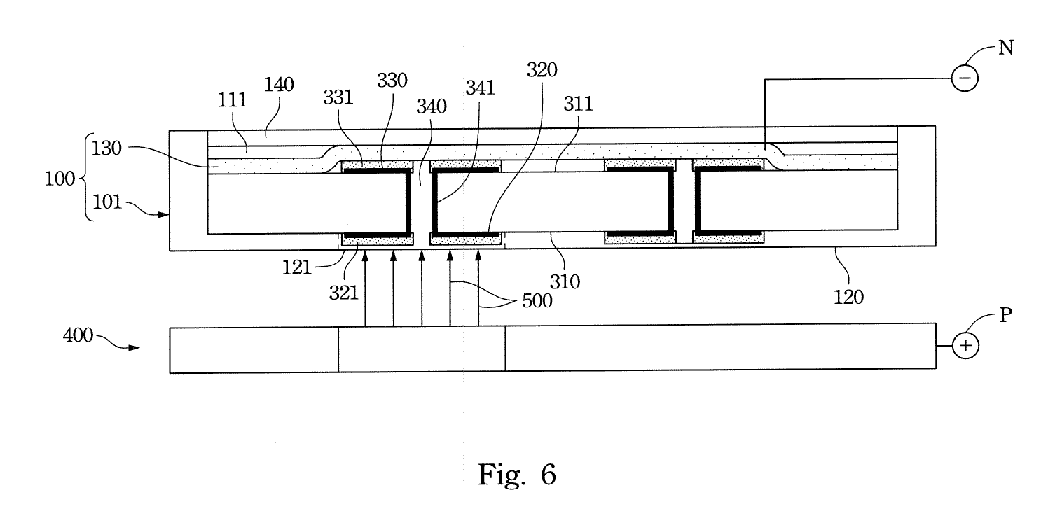

Reference will now be made to FIG. 5 and FIG. 6 in which FIG. 5 is a flowchart illustrating the electroplating method provided by the present invention, and FIG. 6 is a schematic view illustrating the operation of the STEP (204) according to the electroplating method provided by the present invention.

According to the present invention, one electroplating method incorporating with the electroplating jig 100 is not limited to the primary or the selective secondary electroplating, and not limited to be applied in a planar electroplating equipment 400, the electroplating method disclosed in this embodiment are as outlined below.

In step (201), the electro 200 and the electroplating jig 100 are assembled (as shown in FIG. 2). Specifically, in this step, the electro 200 is received in the accommodation slot 111 of the base 101, so the first metal pattern 320 can be exposed from the opening 121, then the soft electric conductive pad 130 is used to cover thereon for ensuring the electrical connection between soft electric conductive pad 130 and the second metal pattern 330, then the soft electric conductive pad 130 is electrically connected to the cathode N of a power source (as shown in FIG. 6);

In step (202), the first metal pattern 320 in the opening 121 is activated. Specifically, in this step, an activation solution is used for removing the oxide film on the surface of the first metal pattern 320 or a metal electroplating layer on the first metal pattern 320.

When being applied in the selective secondary electroplating, the metal electroplating layer on the first metal pattern 320 is processed with an operation of removing the oxidize film on the surface.

In step (203), the first metal pattern 320 in the opening 121 is cleaned with fresh water. Specifically, in this step, purified water or warm water is used to clean the wastes and residual objects after the STEP (202) is processed.

In step (204), an electroplating operation is processed to the first metal pattern 320 in the opening 121 (as shown in FIG. 6). Specifically, in this step, the first metal pattern 320 in the opening 121 of the electroplating jig 100 is sprayed with an electroplating solution 500 for electroplating another metal electroplating layer on the first metal pattern 320. When being applied in the selective secondary electroplating, the metal electroplating layer originally formed on the first metal layer 320 can be electroplated with further metal electroplating layer thereon.

In the electroplating operation, the planar electroplating equipment 400 is electrically connected to the positive electrode P of the power source, the electroplating solution 500 sprayed by the planar electroplating equipment 400 is also electrically connected to the positive electrode P of the power source, when the electroplating solution 500 is in contact with the first metal pattern 320 or the existed metal electroplating layer on the first metal pattern 320, the positive electrode P is electrically connected to the cathode N through the first metal pattern 320, the second metal pattern 330 and the soft electric conductive pad 130, so metal ions in the electroplating solution 500 are able to attach on the first metal pattern 320 or the existed metal electroplating layer on the first metal pattern 320, so as to form the further metal electroplating layer.

According to this embodiment, the electroplating solution 500 is an electric conductive solution or a metal solution mixed with a certain ratio, wherein the metal solution includes gold, silver, copper, nickel or an alloy thereof.

In step (205), the another metal electroplating layer of the first metal pattern 320 in the opening 121 is cleaned with fresh water. Specifically, in this step, the purified water or warm water is again used to clean the further metal electroplating layer of the first metal pattern 320 in the opening 121.

In step (206), the electroplating solution 500 residual in the fresh water is then recycled. Particularly, in this step, through recycling the purified water or warm water, the residual electroplating solution 500 can be recycled, so the electroplating solution 500 can be effectively reused.

In step (207), an anti oxidation treatment is processed to the further metal electroplating layer of the first metal pattern 320 in the opening 121. Particularly, in this step, an agent for increasing the anti oxidation capability for the surface electroplated with metal for enhancing the anti oxidation capability of a finished product.

As such, with the mentioned electroplating method, an electro product 220 can be produced.

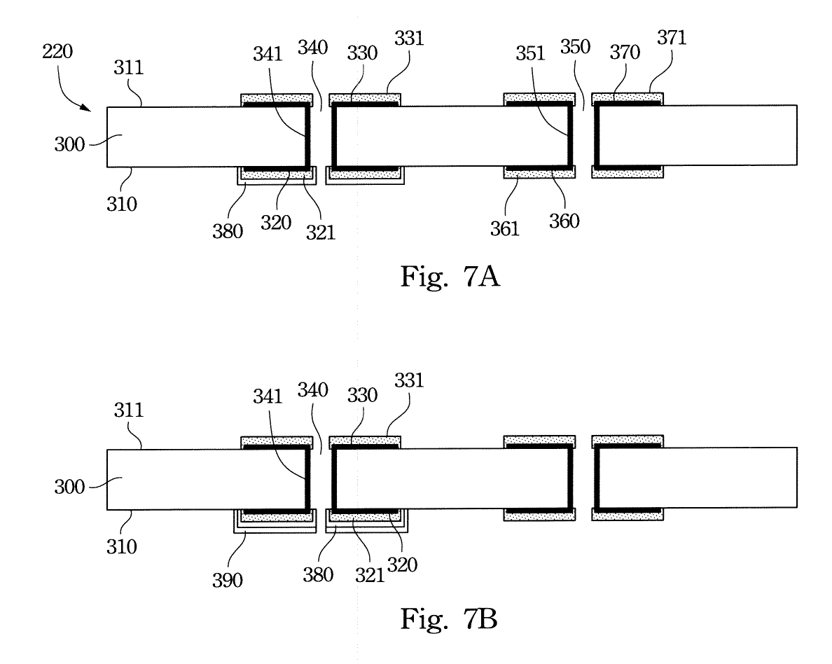

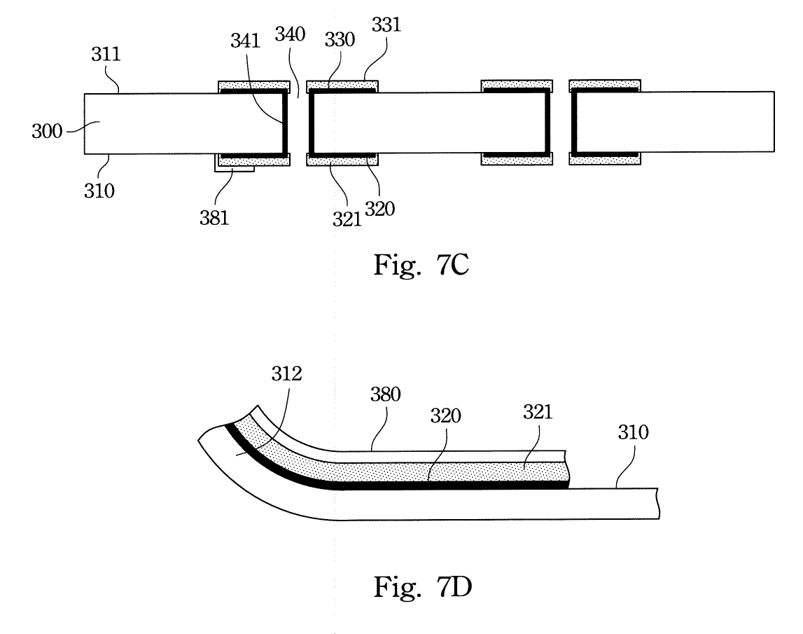

Reference will now be made to FIG. 7A, and FIG. 7A is a schematic view showing an alternative of the electro product 220 according to the present invention.

The electro product 220 includes a carrier 301. The carrier 301 includes a first surface 310, a second surface 311, a first penetrated hole 340 and a second penetrated hole 350. The first surface 310 and the second surface 320 are opposite to each other, the first penetrated hole 340 and the second penetrated hole 350 both penetrate the carrier 301, and the first penetrated hole 340 and the second penetrated hole 350 are both in communication with the first surface 310 and the second surface 311.

The electro product 220 further includes a first metal pattern 320, a second metal pattern 330, a third metal pattern 360, a fourth metal pattern 370, a first metal conductive portion 341 and a second metal conductive portion 351. The first metal pattern 320 is formed on the first surface 310 and located neighboringly to the first penetrated hole 340. The second metal pattern 330 is formed on the second surface 311 and located neighboringly to the first penetrated hole 340. The first metal conductive portion 341 is disposed in the first penetrated hole 340, and electrically connected to the first metal pattern 320 and the second metal pattern 330. The third metal pattern 360 is formed on the first surface 310 and located neighboringly to the second penetrated hole 350. The fourth metal pattern 370 is formed on the second surface 311 and located neighboringly to the second penetrated hole 350. The second metal conductive portion 351 is disposed in the second penetrated hole 350, and electrically connected to the third metal pattern 360 and the fourth metal pattern 370.

The electro product 220 further includes a first meal electroplating layer 321, a second metal electroplating layer 331, a third metal electroplating layer 361, a fourth metal electroplating layer 371 and a first metal secondary electroplating layer 380. The first metal electroplating layer 321 is coated to cover on the first metal pattern 320, the second metal electroplating layer 331 is coated to cover on the second metal pattern 330, the third metal electroplating layer 361 is coated to cover on the third metal pattern 360 and the fourth metal electroplating layer 371 is coated to cover on the fourth metal layer 371. The first metal secondary electroplating layer 380 is coated to cover on the first metal electroplating layer 321, or further, the first metal secondary electroplating layer 380 is completely covered on the first metal electroplating layer 321.

According to this embodiment, because the first surface 310 of the carrier 301 only sets the first metal electroplating layer 321 of the first metal pattern 320 as the electroplating target, the third metal pattern 360 of the first surface 310 of the carrier 301 is not the electroplating target, therefore the third metal pattern 360 is exposed to the atmosphere which means the third metal pattern 360 is covered with nothing. According to another embodiment of the present invention, the first metal secondary electroplating layer 380 and the first metal electroplating layer 321 can adopt the same or different metal materials with respect to the actual needs.

Other than a prior method of utilizing a plating proof layer (e.g. a plating proof paint, plating proof solution or plating proof film) for preventing the unexpected location from being plated, one major disadvantage of the mentioned method is that the plating proof layer would be permanently under the surface of the carrier 301, the third metal pattern 360 of the first surface 310 of the carrier 301 does not require a plating proof layer, so the plating proof layer can be saved, thereby preventing the plating proof layer from damaging the surface of the carrier 301.

FIG. 7B is a schematic view showing another alternative of the electro product according to the present invention. According to FIG. 7A, the mentioned electro product can be processed with the electroplating method for one more times, so the first metal secondary electroplating layer 380 can be covered with a second metal secondary electroplating layer 390, so as to produce a multiple layer structure formed by the first metal secondary electroplating layer 380 and the second metal secondary electroplating layer 390.

FIG. 7C is a schematic view showing one another alternative of the electro product according to the present invention. According to FIG. 7A, the mentioned electro product can be processed with the electroplating method for one more times, with the redesign of the opening 121 of the electroplating jig 100, the first metal secondary electroplating layer 381 can be partially covered on the first metal electroplating layer 321.

FIG. 7D is a schematic view showing still one another alternative of the electro product according to the present invention. When the electroplating target of the electro 200 is in a three dimensional shape, the electroplating target, e.g. the first metal pattern 320, of the electro 200 can still be sprayed with the electroplating solution 500 inside the opening 121 for forming a three dimensional first metal secondary electroplating layer 380.

Substantially, the first surface 310 of the carrier 301 of the electro product 220 is in the three dimensional shape, and includes an arc-shaped surface 312, wherein the first metal pattern 320, the first metal electroplating layer 321 and the first metal secondary electroplating layer 380 are formed on the arc-shaped surface 312.

As what has been disclosed above, the electroplating jig, the electroplating method and the electro product having no plating proof layer provided by the present invention, even when the electroplating target of the electro is in the three dimensional shape, the electroplating jig can still be used to achieve the objective of electroplating at certain location, thereby lowering the manufacturing and labor cost. In addition, with the electroplating jig for processing electroplating at certain location incorporating with the electroplating method of the electroplating job provided by the present invention, only the electroplating target of the electro is exposed, and other locations not being defined as the electroplating targets are shield, thereby preventing the electroplating solution from polluting the other locations which are not electroplating targets defined on the electro.

Although the present invention has been described with reference to the preferred embodiments thereof, it is apparent to those skilled in the art that a variety of modifications and changes may be made without departing from the scope of the present invention which is intended to be defined by the appended claims.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An electroplating jig for processing electroplating at a certain location, applicable to being adopted into an electroplating process together with an electro having two opposite surfaces which respectively have a first metal pattern and a second metal pattern being electrically connected, the electroplating jig comprising:
a base comprising:
a first surface having an accommodation slot concavely formed thereon, wherein the accommodation slot is configured to receive the electro thereinto; and
a second surface arranged oppositely to the first surface, and having an opening formed thereon, wherein the opening is smaller than the accommodation slot, and is in communication with the accommodation slot, and the opening is configured to expose the first metal pattern of the electro from the opening; and
a flexible electric conductive pad removably covered the accommodation slot, configured to conform to a contour of the electro to cover on both of the electro and the second metal pattern so as to electrically connect the first metal pattern and the second metal pattern.

2. The electroplating jig according to claim 1 further comprising:
an outer cover for covering and pressing the flexible electric conductive pad on the electro.

3. The electroplating jig according to claim 1, wherein the flexible electric conductive pad is an electric conductive rubber, an electric conductive fabric or an electric conducive tape.

4. The electroplating jig according to claim 1, wherein the base comprises silicon insulation material.

5. The electroplating jig according to claim 1, wherein when the electro is received in the accommodation slot, the communication between the opening and the accommodation slot is blocked.

6. The electroplating jig according to claim 1, wherein the first metal pattern is formed in a three dimensional shape, the opening is with a depth, and is deep enough to have the first metal pattern accommodated therein.

7. An electroplating method, comprising:
placing an electro in the electroplating jig according to claim 1, wherein the flexible electric conductive pad is electrically connected to a cathode electrode of a power source; and
spraying an electroplating solution on the first metal pattern in the opening of the electroplating jig to conduct the electroplating process to the first metal pattern, wherein the electroplating solution is electrically connected to a positive of the power source.

8. The electroplating method according to claim 7, before the spraying, further comprising:
activating the first metal pattern in the opening; and
cleaning the first metal pattern in the opening with fresh water.

9. The electroplating method according to claim 7, after spraying, further comprising:
cleaning the first metal pattern in the opening with fresh water; and
recycling the electroplating solution residual in the fresh water.

10. An electro product, free of a plating proof layer and produced by the electroplating method according to claim 7, comprising:
a carrier having a first surface, a second surface and a penetrated hole, wherein the first surface is opposite to the second surface, and the penetrated hole is communicated with the first surface and the second surface;
a first metal pattern formed on the first surface;
a first metal electroplating layer formed on the first metal pattern, and electrically connected to the first metal pattern;
a second metal pattern formed on the second surface;
a second metal electroplating layer formed on the second metal pattern, and electrically connected to the second metal pattern;
a first metal conductive portion disposed in the penetrated hole, electrically connected to the first metal pattern and the second metal pattern;
a third metal pattern formed on the first surface;
a third metal electroplating layer formed on the third metal pattern, and electrically connected to the third metal pattern, wherein the third metal electroplating layer is exposed to the atmosphere; and
a metal secondary electroplating layer formed on the first metal electroplating layer, and electrically connected to the first metal electroplating layer.

11. The electro product according to claim 10, wherein the metal secondary electroplating layer is fully or partially covered on the first metal electroplating layer.

12. The electro product according to claim 10, wherein metal material of the metal secondary electroplating layer and the first metal electroplating layer are the same or different.

13. The electro product according to claim 10, wherein the metal secondary electroplating layer is formed as a single or multiple layer structure.

14. The electro product according to claim 10, wherein the third metal electroplating layer is not formed with the plating proof layer.

15. The electro product according to claim 10, wherein the first surface is in the three dimensional shape, and comprises an arc-shaped surface,
wherein the first metal pattern, the first metal electroplating layer and the metal secondary electroplating layer are formed on the arc-shaped surface.
